(19) United States
(12) Patent Application Publication
(10) Pub. No.: US 2026/0203385 A1
(43) Pub. Date: Jul. 16, 2026

(54) TWO-FACTOR FACIAL RECOGNITION AUTHENTICATION

(71) Applicant: Telefonaktiebolaget LM Ericsson (publ), Stockholm (SE)

(72) Inventors: Peter ÖKVIST, Lulea (SE); Niklas LINDSKOG, Lund (SE); Tommy ARNGREN, Sodra Sunderbyn (SE)

(21) Appl. No.: 19/135,974

(22) PCT Filed: Dec. 5, 2022
(86) PCT No.: PCT/SE2022/051142

§ 371 Date: Jun. 5, 2025

(51) Int. Cl. G06F 21/32; G06V 10/74; G06V 10/764; G06V 40/16; G06V 40/70

(52) U.S. Cl. CPC G06F 21/32; G06V 10/74; G06V 10/764; G06V 40/172; G06V 40/174; G06V 40/70

(57) ABSTRACT

There is provided techniques for two-factor facial recognition authentication of a user. A method is performed by an authentication device. The method comprises performing a facial recognition process. The method further comprises performing a challenge-response evaluation process. There is also provided an authentication device configured to perform such a method. There is further provided a computer program for implementing the two-factor facial recognition authentication of the user.

### TECHNICAL FIELD

Embodiments presented herein relate to a method, an authentication device, a computer program, and a computer program product for two-factor facial recognition authentication of a user.

### BACKGROUND

Facial authentication, also referred to as face, or facial, recognition authentication, is a biometric authentication technique that is based on performing facial recognition of a user to be authenticated. Facial authentication can be used to allow a user access to a device equipped with a camera, such as a smartphone, a tablet computer, or a laptop computer, but also to an industrial site, a building, or a room, where the entry access system is equipped with a camera.

Some implementations of facial authentication techniques have been proven to be vulnerable to attacks where pictures, or movies, or a projection of the user's face as a hologram, etc. of a legitimate user are falsely accepted during authentication.

In this respect, it is noted that the human face is one of the most changeable type of biometrics as used in biometric authentication techniques. Fingerprints as well as the iris, or retina, of an eye iris are relatively static and change little over time. In contrast, the human face can be altered in several different ways. Both temporary (in terms of different facial expressions), intermittently (in terms of micro expressions), semi-temporary (in terms of facial hair, makeup, piercings, jewelry, etc.), and long-term (in terms of tattoos, facial surgery, aging, illness, medical conditions, etc.).

At least the temporary changes can be exploited to combine facial authentication with facial expressions/emotions, which requires the attacker to be able to replicate not only a certain human face, but also give that human face a certain facial expression/emotion for successful authentication. For the task of using face emotion recognition (FER) for authentication, a model of hybrid biometric-based authentication is described in “Fusion of Face Recognition and Facial Expression Detection for Authentication: A Proposed Model”, by Delina Beh Mei Yin et al. in Proceedings of the 11th International Conference on Ubiquitous Information Management and Communication, January 2017, DOI: 10.1145/3022227.3022247. It is stated that recognition accuracy of a single biometric verification system is often much reduced due to many factors such as the environment, user mode and physiological defects of an individual. Apparently, the enrolment of static biometric is highly vulnerable to impersonation attack. Due to the fact of single biometric authentication only offers one factor of verification, it is proposed to use a hybrid of two biometric attributes that consist of physiological and behavioral trait, via utilization of static and dynamic features of a human face. To extract the important features from a face, the primary steps taken are image pre-processing and face detection. To distinguish between a genuine user or an imposter, the first authentication is to verify the user's identity through face recognition. It is disclosed that solely depending on a single modal biometric, is possible to lead to false acceptance when two or more similar face features may result in a relatively high match score. As further improvement a fusion method is proposed whereby a genuine user will select a facial expression from the seven universal expressions (happy, sad, angry, disgusted, surprised, fear, neutral) as enrolled earlier in the database.

Whilst adding a constraint on a certain facial expression and/or emotion to the facial authentication process, the number of possible expressions may be small; in the above list there are only seven different expressions. This allows an attacker to repeat the attempt until a facial expression which it can recreated is selected. Furthermore, it is relatively easy to create an emotion on a modified picture of the legitimate user (e.g., using so-called deepfake technology). As an example, U.S. Pat. No. 10,956,548B2 describes a method where the user is authenticated responsive to determining that a facial expression of the user corresponds to an accepted facial expression associated with a given emotion and the facial expression comprises the facial features associated with an authorized user. U.S. Pat. No. 10,956,548B2 does not require any secret relationship between the prompt and the expected emotion shown by the user. I.e., it will be clear for all parties that it is a certain emotion that is requested, and therefore, an attacker may readily defeat the described system by presenting an image of the user having the requested emotion.

Another approach involves combining facial authentication with some other authentication technique, for example requiring the user to also enter a passcode, password, passphrase, etc., or to complete a voice recognition process, for the user to be authenticated. Whilst this improves security, it requires the user to utilize another input means (such as a keypad or keyboard, or a microphone, and is therefore not suitable in all scenarios (e.g., where the additional input means are lacking). Further, it requires at least two types of data to be recorded and processed for the authentication.

Hence, there is still a need for improved facial recognition authentication techniques.

### SUMMARY

An object of embodiments herein is to provide facial recognition authentication that does not suffer from the above issues, or at least where the above issues have been mitigated or reduced.

According to a first aspect there is presented a method for two-factor facial recognition authentication of a user. The method is performed by an authentication device. The method comprises performing a facial recognition process. The facial recognition process comprises obtaining, via an image sensor, a first facial image of the user. The facial recognition process comprises recognizing the user by performing facial recognition on the first facial image. The method comprises performing a challenge-response evaluation process. The challenge-response evaluation process comprises providing a challenge to the user by playing out at least one media item to the user. The at least one media item is selected from a set of available media items for the user and is associated with a face emotion selected from a set of available face emotions. The challenge-response evaluation process comprises obtaining, via the image sensor, a response to the challenge from the user. The response is a second facial image of the user. The challenge-response evaluation process comprises classifying the second facial image to one of the face emotions in the set of face emotions by performing face emotion recognition on the second facial image. The challenge-response evaluation process comprises successfully authenticating the user, responsive to the face emotion of the second facial image matching the face emotion associated with the at least one media item.

According to a second aspect there is presented an authentication device for two-factor facial recognition authentication of a user. The authentication device comprises processing circuitry. The processing circuitry is configured to cause the authentication device to perform a facial recognition process. According to the facial recognition process, the processing circuitry causes the authentication device to obtain, via an image sensor, a first facial image of the user. According to the facial recognition process, the processing circuitry causes the authentication device to recognize the user by performing facial recognition on the first facial image. The processing circuitry is configured to cause the authentication device to perform a challenge-response evaluation process. According to the challenge-response evaluation process, the processing circuitry causes the authentication device to provide a challenge to the user by playing out at least one media item to the user. The at least one media item is selected from a set of available media items for the user and is associated with a face emotion selected from a set of available face emotions. According to the challenge-response evaluation process, the processing circuitry causes the authentication device to obtain, via the image sensor, a response to the challenge from the user. The response is a second facial image of the user. According to the challenge-response evaluation process, the processing circuitry causes the authentication device to classify the second facial image to one of the face emotions in the set of face emotions by performing face emotion recognition on the second facial image. According to the challenge-response evaluation process, the processing circuitry causes the authentication device to successfully authenticate the user, responsive to the face emotion of the second facial image matching the face emotion associated with the at least one media item.

According to a third aspect there is presented a computer program for two-factor facial recognition authentication of a user. The computer program comprises computer code which, when run on processing circuitry of an authentication device, causes the authentication device to perform actions.

One action comprises the authentication device to perform a facial recognition process. According to the facial recognition process, the authentication device is caused to obtain, via an image sensor, a first facial image of the user. According to the facial recognition process, the authentication device is caused to recognize the user by performing facial recognition on the first facial image. One action comprises the authentication device to perform a challenge-response evaluation process. According to the challenge-response evaluation process, the authentication device is caused to provide a challenge to the user by playing out at least one media item to the user. The at least one media item is selected from a set of available media items for the user and is associated with a face emotion selected from a set of available face emotions. According to the challenge-response evaluation process, the authentication device is caused to obtain, via the image sensor, a response to the challenge from the user. The response is a second facial image of the user. According to the challenge-response evaluation process, the authentication device is caused to classify the second facial image to one of the face emotions in the set of face emotions by performing face emotion recognition on the second facial image. According to the challenge-response evaluation process, the authentication device is caused to successfully authenticate the user, responsive to the face emotion of the second facial image matching the face emotion associated with the at least one media item.

According to a fourth aspect there is presented a computer program product comprising a computer program according to the third aspect and a computer readable storage medium on which the computer program is stored. The computer readable storage medium could be a non-transitory computer readable storage medium.

Advantageously, these aspects provide facial recognition authentication that does not suffer from the above issues.

Advantageously, these aspects provide an authentication technique that is resilient to interception, eavesdropping, and replication.

Advantageously, these aspects make it challenging for an attacker to know in what manner, i.e., with what facial expression, the user actually is intended (or used) to react to a certain media item. In turn, this makes it challenging for an attacker to replicate what the response to the challenge would be.

Advantageously, an attacker will have difficulties to have a priori knowledge of what media items that are associated with a certain user. In turn, this makes it challenging for an attacker to, beforehand, make any preparations with regards how to respond to a given challenge. That is, an attacker could not reasonably make any preparations in advance since the attacker would not be able to guess (i) which media items are associated with a certain user, and (ii) which facial expression is associated with each of the, thus unknown, media items (and possibly in combination with providing an image of the user that replicates the required facial expression).

In that, an attacker may likely not know the user's expected facial expressions in response to a certain media item.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a facial recognition authentication system according to embodiments;

FIG. 2 is a schematic diagram illustrating the principal components of a facial recognition authentication system according to embodiments;

FIGS. 3 and 4 are flowcharts of methods according to embodiments;

FIG. 5 is a schematic diagram showing functional units of an authentication device according to an embodiment; and

FIG. 6 shows one example of a computer program product comprising computer readable storage medium according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

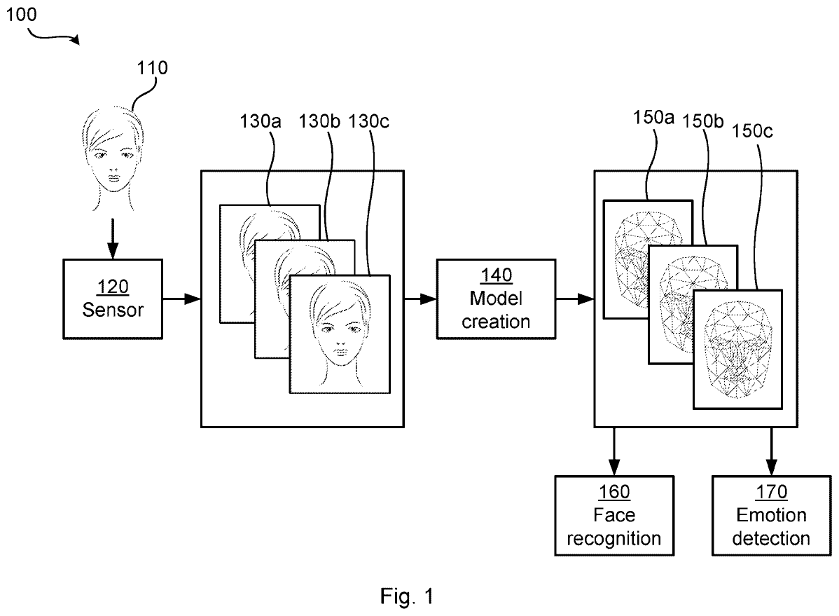

In FIG. 1 is illustrated the principal components of a facial recognition authentication system 100 for authenticating a user 110. An image sensor 120 is configured to capture facial images 130a, 130b, 130c of the user 110. A model creation module 140 generates one facial model 150a, 150b, 150c per each of the facial images 130a, 130b, 130c. A face recognition module 160 is configured to analyze each facial model 150a, 150b, 150c to recognize the user 110 in each of the facial images 130a, 130b, 130c. An emotion detection module 170 is configured to analyze each facial model 150a, 150b, 150c to estimate the emotion, or facial expression, of the user 110 in each of the facial images 130a, 130b, 130c. Without any further modifications, the facial recognition authentication system 100 might thereby authenticate a user 110 based on facial recognition and an expected emotion, or facial expression, of the user 110.

As noted above, there is still a need for improved facial recognition authentication techniques. The embodiments disclosed herein therefore relate to techniques for two-factor facial recognition authentication of a user 110, 230. In order to obtain such techniques there is provided an authentication device, a method performed by the authentication device, a computer program product comprising code, for example in the form of a computer program, that when run on an authentication device, causes the authentication device to perform the method.

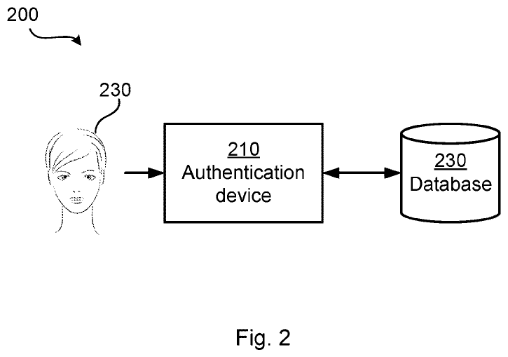

In FIG. 2 is illustrated the principal components of a facial recognition authentication system 200 for authenticating a user 230 according to embodiments. The facial recognition authentication system 200 comprises an authentication device 210 and a database 220. The authentication device 210 is operatively connected to, or at least has access to, the database 220. The database 220 holds sets of media items (with one set of media items being available per each user 230 to be authenticated) and a respective association between each media item and a face emotion (where the face emotion is selected from a set of available face emotions). Non-limiting examples of media types are audio files (such as music, spoken words, sounds, etc.), video files, text files (such as text excerpts from email, messages, or conversation, lyrics, etc.), image files, or haptic response files (such as light flickering patterns, vibration patterns, etc.). Non-limiting examples of face emotion are happy, sad, angry, disgusted, surprised, fear, confused, calm, neutral, possibly in combination with one or more micro-expressions.

The authentication device 210 is operatively connectable to, or comprises, the image sensor 120 in FIG. 1 such that the authentication device 210 is capable of obtaining facial images 130a, 130b, 130c as captured of the user 230. Further, the authentication device 210 is operatively connectable to, or comprises, the model creation module 140 in FIG. 1 such that the authentication device 210 is capable of obtaining facial models 150a, 150b, 150c of the user 230. Hence, the authentication device 210 is capable of obtaining facial images 130a, 130b, 130c of the user 230 and of extracting, based on the facial images 130a, 130b, 130c, features representing the user 230. It is here further assumed that the authentication device 210 is operatively connectable to, or comprises, the face recognition module 160 and the emotion detection module 170 of FIG. 1 such that the authentication device 210 is capable of analyzing each facial model 150a, 150b, 150c to recognize the user 230 in each of the facial images 130a, 130b, 130c and estimating the emotion, or facial expression, of the user 230 in each of the facial images 130a, 130b, 130c.

Further, the authentication device 210 might be configured with information of one or more user face emotion metrics associated with certain media items (or sequences of media items). Further, the authentication device 210 might be configured with information of one or more user-emotion reaction fulfilment requirements (e.g., thresholds) per played out media item or per entire sequence of consecutively played out media items, per authentication, etc.

Further, the authentication device 210 might be configured to select which media items to be used for authenticating the user 230, the minimum number of media items to be used for authenticating the user 230, thresholds for facial recognition and face emotion estimation, etc. based on what device, application, process, service, or task the user 230 is to be authenticated for. In this respect, each device, application, process, service, or task might be associated with its own authentication level; the higher the authentication level, the higher the minimum number needs to be, etc.

Further, the authentication device 210 is configured to play out media items from the database 220 to the user 230. It is here therefore further assumed that the authentication device 210 is operatively connectable to, or comprises, a user interface module for playing out media items to the user 230. There might be different types of user interface modules depending on the type of media item to be played out, e.g., a display for playing out media items in terms of video files, image files, or text files, and a speaker for playing out media items in terms of audio files. Each media item that is played out is, as disclosed above, associated with one of the face emotions. In this respect, the authentication device 210 might be configured to select media items to be played out based on information as provided by the emotion detection module 170 of the emotion, or facial expression, of the user 230.

Further, the authentication device 210 is configured to, by means of the face recognition module 160 and the emotion detection module 170, perform facial recognition and emotion detection with the purpose to determine how the user 230 reacts, in terms of face emotion, when a certain media item is played out to the user 230.

Further, the authentication device 210 is configured to provide a result (e.g., pass or fail) of the authentication as input to the device, application, process, service, or task the user 230 is to be authenticated for. For this purpose, the authentication device 210 might be provided with a communication interface and support one or more communication protocols for communicating the result.

The execution of operations as carried out by the authentication device 210 might be split between a server and a client. The client might reside in a device that the user 230 interacts with for being authenticated (such as a smartphone, a tablet computer, a laptop computer, or an entry access system). Further, operations carried out by the server might either be centrally implemented in one single physical computing device or be distributively implemented in different physical computing devices, e.g., in a cloud computational environment.

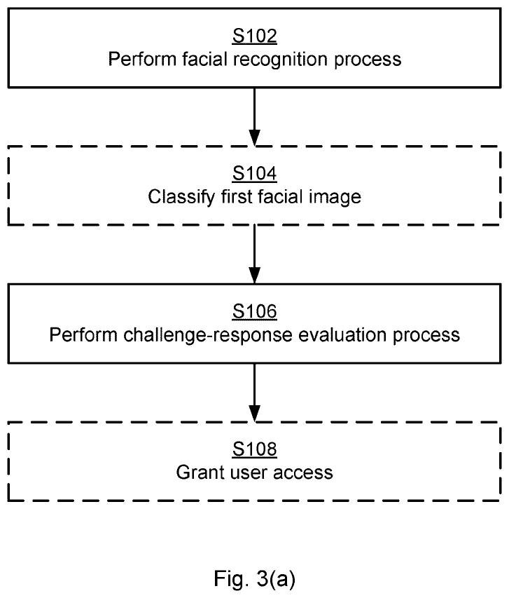

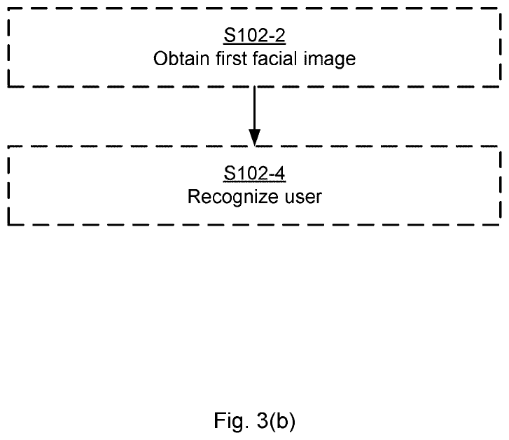

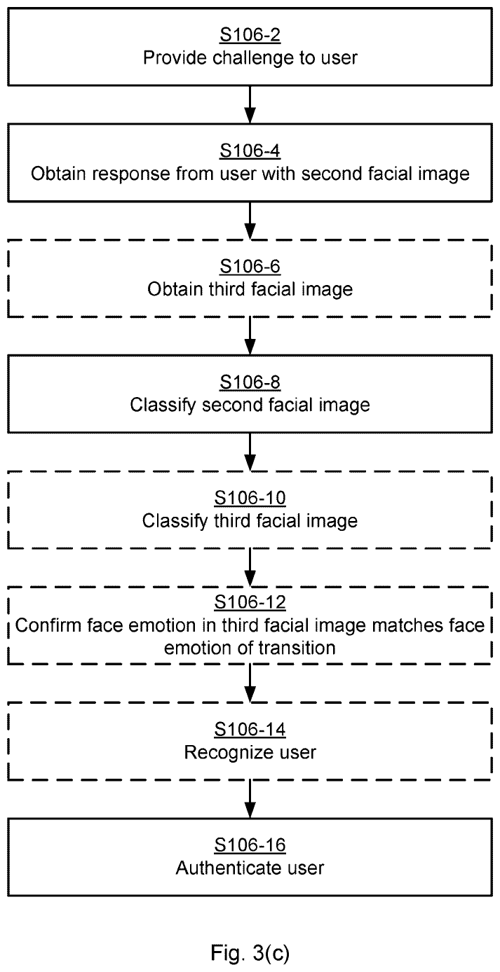

FIG. 3 (as divided into FIGS. 3(a), 3(b), and 3(c)) is a flowchart illustrating embodiments of methods for two-factor facial recognition authentication of a user 110, 230. The methods are performed by the authentication device 210, 500. The methods are advantageously provided as computer programs.

The methods are based on two-factor facial recognition authentication involving a facial recognition process S102 and a challenge-response evaluation process S106.

Hence, the authentication device 210, 500 is configured to perform steps S102 and S106:
S102: The authentication device 210, 500 performs a facial recognition process.
S106: The authentication device 210, 500 performs a challenge-response evaluation process.

In general terms, the purpose of the facial recognition process S102 is to recognize the user, whilst the purpose of the challenge-response evaluation process S106 is to authenticate the user.

Details of the facial recognition process S102 will be disclosed next.
S102-2: The authentication device 210, 500 obtains, via an image sensor 120, a first facial image 130a of the user 110, 230.
S102-4: The authentication device 210, 500 recognizes the user 110, 230 by performing facial recognition on the first facial image 130a.

In this respect, the challenge-response evaluation process S106 might only been performed if the facial recognition process S102 is successful, i.e., that the user can be recognized by the authentication device.

Details of the challenge-response evaluation process S106 will be disclosed next.

The challenge includes a request for an emotion that the user holds with respect to at least one media item, as in step S106-2.
S106-2: The authentication device 210, 500 provides a challenge to the user 110, 230 by playing out at least one media item to the user 110, 230. The at least one media item is selected from a set of available media items for the user 110, 230 and is associated with a face emotion selected from a set of available face emotions.

The response is a face emotion as given by the user in reaction to the at least one media item being played out, as in step S106-4.
S106-4: The authentication device 210, 500 obtains, via the image sensor 120, a response to the challenge from the user 110, 230, wherein the response is a second facial image 130b of the user 110, 230.

The authentication device 210, 500 then uses classification to evaluate both the face and the resemblance to at least one associated face emotion, as in step S106-8.
S106-8: The authentication device 210, 500 classifies the second facial image 130b to one of the face emotions in the set of face emotions by performing face emotion recognition on the second facial image 130b.

In some aspects, each face emotion corresponds to a facial expression, and hence the terms face emotion and facial expression can be used interchangeably.

Authentication is performed based on the result of the classification in step S106-8, as in step S106-16.
S106-16: The authentication device 210, 500 successfully authenticates the user 110, 230, responsive to the face emotion of the second facial image 130b matching the face emotion associated with the at least one media item.

In this respect, in some examples, one and the same media item requires a certain sequence of face emotions to be produced by the user in reaction to this one and the same media item being played out. Hence, in S106-4 one separate image for each face emotion in the sequence of face emotions might be obtained in S106-4, followed by a classification of each separate image in S106-8 (yielding a classified sequence of face emotions), and where the authentication in S106-16 is based on comparing the classified sequence of face emotions to an expected sequence of face emotions for the one and the same media item played out in S106-2.

In this respect, the user might be successfully authenticated if a threshold-target resemblance value for the matching is fulfilled.

This method can be seen as an improvement of face recognition authentication, where the user additionally is presented with challenge (in terms of a media item) that is associated with a certain response (in terms of a face emotion). A successful authentication requires not only the user to have the correct face but also to provide the correct face emotion in response to the at least one media item being played out.

Embodiments relating to further details of two-factor facial recognition authentication of a user 110, 230 as performed by the authentication device 210, 500 will now be disclosed with continued reference to FIG. 3.

There may be different examples of media items. In some non-limiting examples, the set of available media items comprises media items in terms of any, or any combination of: audio files, video files, text files, image files, and/or haptic response files (i.e., files for playing out haptic signals). Each haptic signal can be played out as a sequence of one or more vibrations, a sequence of one or more light flickers, etc., possibly with different intensity levels per vibration, or light flicker.

In some aspects, the media item is transformed from one type to another before being played out. That is, in some embodiments, playing out the at least one media item to the user 110, 230 comprises transforming the at least one media item from a first type to a second type. Such a transformation might be needed depending on the capabilities of the device at hand. For example, a text file can be played out as an audio file by performing text-to-speech processing on the text file, etc.

In some aspects, the media item played out as part of the challenge is adapted to the context and the current emotional state of the user, as represented by the current face emotion of the user to be authenticated. The authentication device 210, 500 might therefore record the current face emotion of the user prior to selecting which media item to be part of the challenge, and based on that face emotion, select a preferred set of media items to play out. Therefore, in some embodiments, the method comprises step S104.
S104: The authentication device 210, 500 classifies the first facial image 130a to one of the face emotions in the set of face emotions by performing face emotion recognition on the first facial image 130a. The at least one media item in the challenge-response evaluation process can then be selected from the set of available media items for the user 110, 230 as a function of the face emotion of the first facial image 130a.

With respect to the face emotion recognition as performed in steps S104 and S106-8, In some aspects, emotion recognition is used to establish a confidence value (for example provided as a probability value) with respect to each detected face emotion. The output of the face emotion recognition might therefore be a vector with confidence values for different estimated face emotions. One example of a vector with confidence values for different estimated face emotions obtained by classification of a facial image of a user is provided in Table 1. According to the example numerical values in Table 1, the face emotion is classified as “Happy” since its confidence value is highest.

TABLE 1
Example of estimated face emotions based
on analysis of a facial image of a user

| Confidence | Type |
|---|---|
| 0.00% | Disgusted |
| 78.8% | Happy |
| 4.80% | Surprised |
| 7.10% | Angry |
| 5.70% | Confused |
| 3.60% | Calm |
| 0.00% | Sad |

In some aspects, a sequence of media items is played out. That is, in some embodiments, during the challenge-response evaluation process, the providing in S106-2, the obtaining in S106-4, the classifying in S106-8, and the matching in S106-16 are repeated for a set of challenges as provided to the user 110, 230. During each challenge a respective media item selected from the set of available media items.

In some aspects, the smallest number of media items is determined with respect to targeted authentication level. In particular, in some embodiments, for how many iterations the providing in S106-2, the obtaining in S106-4, the classifying in S106-8, and the matching in S106-16 are to be repeated depends on a targeted authentication level at which the user 110, 230 is to be authenticated. In this respect, the targeted authentication level might in turn be dependent on the device, application, process, service, or task the user 110, 230 is to be authenticated for. In some aspects, the smallest number of media items to be played out with respect to a targeted authentication level, is selected as follows. A lowest authentication level corresponds to, e.g., one single media item being played out. A medium authentication level corresponds to, e.g., more than one media item but less than a ceiling number of media items being played out. A highest authentication level corresponds to, e.g., a ceiling number of media items being played out. Further in this respect, the authentication level might also dictate threshold levels as used in the facial recognition process S102 and/or the challenge-response evaluation process S106.

In some aspects, a new media item is played out until a threshold value to either authenticate the user or not authenticate the user is reached. In particular, in some embodiments, during the challenge-response evaluation process, the providing in S106-2, the obtaining in S106-4, the classifying in S106-8, and the matching in S106-16 are repeated only when the face emotion of the second facial image 130b for one challenge of the challenge-response evaluation process matches the face emotion associated with the at least one media item of said one challenge of the challenge-response evaluation process.

In some aspects, a new media item is played out in response to the user having responded with what is classified as an incorrect face emotion to the challenge. Hence, in some embodiments, during the challenge-response evaluation process, the providing in S106-2, the obtaining in S106-4, the classifying in S106-8, and the matching in S106-16 are repeated until the face emotion of the second facial image 130b for one challenge of the challenge-response evaluation process matches the face emotion associated with the at least one media item of said one challenge of the challenge-response evaluation process.

In some aspects, when a sequence of media items is played out, the user is assumed to respond with a face emotion that is different from neutral only to a media item played out at a certain position in the sequence.

In some aspects, a sequence of media items of different types is played out. Hence, in some embodiments, at least two media items of different types are simultaneously played out to the user 110, 230 when providing the challenge to the user 110, 230.

In some aspects, the user only has limited time to provide a response, in terms of a face emotion, to one and the same media item that is played out. The time during which a media item is played out, and/or the time within which a response to a challenge is required, could depend on the type of media item (i.e., be longer for text files than for images, etc), and/or could depend on the authentication level (i.e., be shorter as the authentication level increases).

In some non-limiting examples, which of the face emotions in the set of face emotions that are associated with each of the media items in the set of available media items is defined by any, or any combination of: an implicit mapping learned whilst playing out the media item in the set of available media items, a training procedure, an explicit mapping provided by the user 110, 230. In some examples, the authentication device 210, 500 might select a least one (or sequence of) media items to train for a certain emotional response, such that the training can be executed in different current modes of emotion. Associating a media item with a face emotion may also be carried out by the user explicitly through a manually executed procedure. The user may in a first step select a preferred media item to which the user holds a certain emotion associated, and which the user intends to correlate a face emotion readout to. In a second step, the emotion paring is invoked e.g., by obtaining a certain face emotion recognition. In a third step, the media-to-emotion training and association (after some repetitions, etc.) associates a face emotion metric to the media item. In a fourth step, the media item is marked as being associative with a certain type of face emotion, and a corresponding metric.

In some aspects, also face emotion as provided by the user in-between two played-out items in a sequence of media items is considered when authenticating the user. That is, as the playing out of media items is changed from media item M1 to media item M2, the face emotion transitions from emotion E1 to emotion E2 via intermittent emotion E12. Then also the intermittent emotion E12 might be considered.

That is, in some embodiments, each transition from the at least one media item played out for a current challenge and the at least one media item played out for a next challenge is associated with a face emotion selected from a set of available face emotions. The challenge-response evaluation process might then further comprise steps S106-6, S106-10, and S106-12.
S106-6: The authentication device 210, 500 obtains, from the image sensor 120, a third facial image 130c of the user 110, 230 for each transition.
S106-10: The authentication device 210, 500 classifies the third facial image 130c for each transition to one of the face emotions in the set of face emotions by performing face emotion recognition on each third facial image 130c.
S106-12: The authentication device 210, 500 confirms that the face emotion of each third facial image 130c matches the face emotion of the transitions before successfully authenticating the user 110, 230.

For example, media item M1 and media item M2 might be provided to evoke a minimum difference between E1 and E2 such that E12 is very similar to E1 and E2. In another example, media item M1 and media item M2 might be provided to evoke a maximum difference between E1 and E2 such that E12 is different from both E1 and E2.

As disclosed above, the challenge-response evaluation process S106 might only been performed if the facial recognition process S102 is successful, i.e., that the user can be recognized by the authentication device. The facial recognition process S102 is performed on the first facial image 130a. In further aspects, an explicit facial recognition as also performed on the second facial image 130b is required before successfully authenticating the user 110, 230. The challenge-response evaluation process S106 might therefore further comprise step S106-14.
S106-14: The authentication device 210, 500 recognizes the user 110, 230 by performing facial recognition on the second facial image 130b before successfully authenticating the user 110, 230.

When the user 110, 230 has been successfully authenticated, the user 110, 230 can be granted access to the requested device, application, process, service, or task, as in step S108.
S108: The authentication device 210, 500 grants the user 110, 230 access to a device, an application, a process, a service, or a task, responsive to having successfully authenticated the user 110, 230.

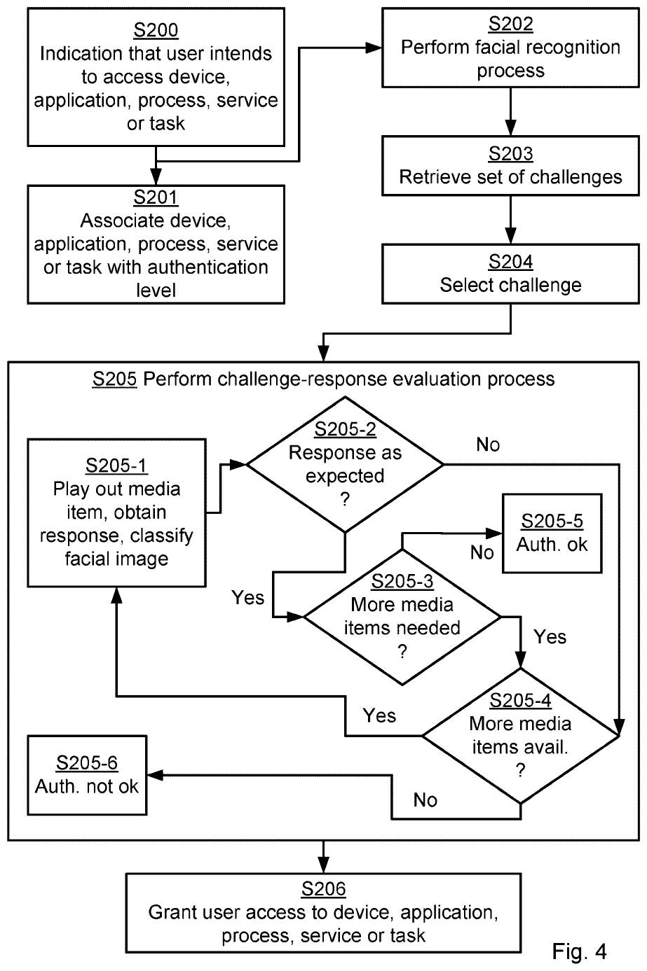

One embodiment of a method for two-factor facial recognition authentication of a user 110, 230 as performed by the authentication device 210, 500 will be disclosed next with reference to the flowchart of FIG. 4. Any step, action, feature, aspect, or example as disclosed hereinafter with reference to FIG. 4 is also applicable to the methods disclosed above with reference to FIG. 3, and vice versa.
S200: An indication is obtained that the user 110, 230 intends to access a device, an application, a process, a service, or a task that requires authentication of the user 110, 230.
S201: The device, application, process, service, or task is associated with an authentication level for the authentication of the user 110, 230.
S202: A facial recognition process is performed on a first facial image 130a of the user 110, 230 to recognize the user 110, 230. The facial recognition process might comprise above disclosed steps S102-2, S102-4. Optionally, step S104 is performed to classify the first facial image 130a to one of the face emotions in the set of face emotions so as to allow the media item to be played out to be adapted to the context and the current emotional state of the user 110, 230.
S203: A set of challenges is retrieved for the user 110, 230 based on the set of available media items for the user 110, 230. Each challenge might involve a single piece of media item to be played our or a sequence of media items to be played out, in accordance with any of the above disclosed embodiments.
S204: The challenge to be used to authenticate the user 110, 230 is selected from the set of challenges based on the authentication level, and optionally the context and the current emotional state of the user 110, 230. The authentication level might, as disclosed above, dictate the minimum number of media items to be played, thresholds to use during the classification of the face emotion, etc. One single challenge might here involve a sequence of media items to be played out.
S205: A challenge-response evaluation process is performed as in step S106 (involving steps S106-2, S106-4, S106-8, S106-16, possibly steps S106-6, S106-10, S106-12, and possibly step S106-14) using the challenge as selected in step S204. In particular, step S205 involves steps S205-1, S205-2, S205-3, S205-4, S205-5, and S205-6.
S205-1: A media item is played out, a response in terms of a facial image of the user is obtained, and the facial image is classified.
S205-2: It is checked whether the result of the classification is as expected, i.e., that the face emotion of the facial image in the response matches the face emotion associated with the just played out media item, or not. If yes, step S205-3 is entered. If no, step S205-4 is entered.
S205-3: It is checked whether more media items needs to be played out. If yes, step
S205-4 is entered. If no, step S205-5 is entered.
S205-4: It is checked whether more media items are available for being played out. If yes, step S205-1 is entered and a new media item is played out. If no, step S205-6 is entered.
S205-5: The authentication of the user is successful.
S205-6: The authentication of the user is unsuccessful.
S206: The authentication device 210, 500 grants the user 110, 230 access to the device, application, process, service, or task, responsive to having successfully authenticated the user 110, 230 in step S205.

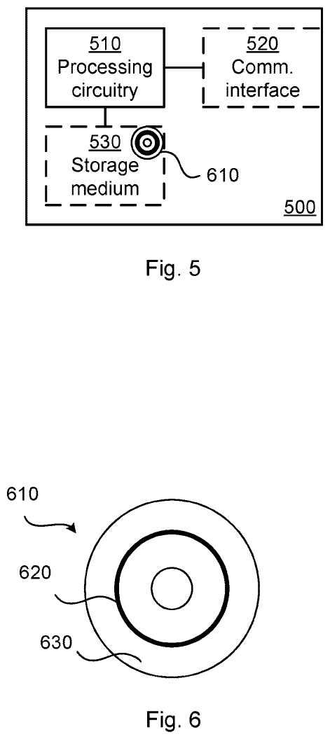

FIG. 5 schematically illustrates, in terms of a number of functional units, the components of an authentication device 210, 500 according to an embodiment. Processing circuitry 510 is provided using any combination of one or more of a suitable central processing unit (CPU), multiprocessor, microcontroller, digital signal processor (DSP), etc., capable of executing software instructions stored in a computer program product 610 (as in FIG. 6), e.g. in the form of a storage medium 530. The processing circuitry 510 may further be provided as at least one application specific integrated circuit (ASIC), or field programmable gate array (FPGA).

Particularly, the processing circuitry 510 is configured to cause the authentication device 210, 500 to perform a set of operations, or steps, as disclosed above. For example, the storage medium 530 may store the set of operations, and the processing circuitry 510 may be configured to retrieve the set of operations from the storage medium 530 to cause the authentication device 210, 500 to perform the set of operations. The set of operations may be provided as a set of executable instructions.

Thus the processing circuitry 510 is thereby arranged to execute methods as herein disclosed. The storage medium 530 may also comprise persistent storage, which, for example, can be any single one or combination of magnetic memory, optical memory, solid state memory or even remotely mounted memory. The authentication device 210, 500 may further comprise a communications (comm.) interface 520 at least configured for communications with other entities, functions, nodes, and devices. As such the communications interface 520 may comprise one or more transmitters and receivers, comprising analogue and digital components. The processing circuitry 510 controls the general operation of the authentication device 210, 500 e.g. by sending data and control signals to the communications interface 520 and the storage medium 530, by receiving data and reports from the communications interface 520, and by retrieving data and instructions from the storage medium 530. Other components, as well as the related functionality, of the authentication device 210, 500 are omitted in order not to obscure the concepts presented herein.

The authentication device 210, 500 may be provided as a standalone device or as a part of at least one further device. Thus, a first portion of the instructions performed by the authentication device 210, 500 may be executed in a first device, and a second portion of the of the instructions performed by the authentication device 210, 500 may be executed in a second device; the herein disclosed embodiments are not limited to any particular number of devices on which the instructions performed by the authentication device 210, 500 may be executed. Hence, the methods according to the herein disclosed embodiments are suitable to be performed by an authentication device 210, 500 residing in a cloud computational environment. Therefore, although a single processing circuitry 510 is illustrated in FIG. 5 the processing circuitry 510 may be distributed among a plurality of devices, or nodes. The same applies to the computer program 620 of FIG. 6.

FIG. 6 shows one example of a computer program product 610 comprising computer readable storage medium 630. On this computer readable storage medium 630, a computer program 620 can be stored, which computer program 620 can cause the processing circuitry 510 and thereto operatively coupled entities and devices, such as the communications interface 520 and the storage medium 530, to execute methods according to embodiments described herein. The computer program 620 and/or computer program product 610 may thus provide means for performing any steps as herein disclosed.

In the example of FIG. 6, the computer program product 610 is illustrated as an optical disc, such as a CD (compact disc) or a DVD (digital versatile disc) or a Blu-Ray disc. The computer program product 610 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 620 is here schematically shown as a track on the depicted optical disk, the computer program 620 can be stored in any way which is suitable for the computer program product 610.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for two-factor facial recognition authentication of a user, the method being performed by an authentication device, the method comprising:
performing a facial recognition process, comprising:
obtaining, via an image sensor, a first facial image of the user; and
recognizing the user by performing facial recognition on the first facial image; and
performing a challenge-response evaluation process, comprising:
providing a challenge to the user by playing out at least one media item to the user, wherein the at least one media item is selected from a set of available media items for the user and is associated with a face emotion selected from a set of available face emotions;
obtaining, via the image sensor, a response to the challenge from the user, wherein the response is a second facial image of the user;
classifying the second facial image to one of the face emotions in the set of available face emotions by performing face emotion recognition on the second facial image; and
successfully authenticating the user, responsive to the face emotion of the second facial image matching the face emotion associated with the at least one media item.

2. The method according to claim 1, wherein each of the face emotions in the set of available face emotions that are associated with each of the media items in the set of available media items is defined by any, or any combination of: an implicit mapping learned whilst playing out the media item in the set of available media items, a training procedure, and an explicit mapping provided by the user.

3. The method according to claim 1, wherein, during the challenge-response evaluation process, said providing, said obtaining, said classifying, and said matching are repeated for a set of challenges as provided to the user, wherein during each challenge a respective media item is selected from the set of available media items.

4. The method according to claim 3, wherein each transition from the at least one media item played out for a current challenge and the at least one media item played out for a next challenge is associated with a face emotion selected from a set of available face emotions, and wherein the challenge-response evaluation process further comprises:
obtaining, from the image sensor, a third facial image of the user for each transition;
classifying the third facial image for each transition to one of the face emotions in the set of available face emotions by performing face emotion recognition on each third facial image; and
confirming that the face emotion of each third facial image matches the face emotion of the transitions before successfully authenticating the user.

5. The method according to claim 3, wherein for how many iterations said providing, said obtaining, said classifying, and said matching are to be repeated depends on a targeted authentication level at which the user is to be authenticated, and wherein at least two media items of different types are simultaneously played out to the user when providing the challenge to the user.

6. The method according to claim 3, wherein, during the challenge-response evaluation process, said providing, said obtaining, said classifying, and said matching are repeated until the face emotion of the second facial image for one challenge of the challenge-response evaluation process matches the face emotion associated with the at least one media item of said one challenge of the challenge-response evaluation process.

7. The method according to claim 3, wherein, during the challenge-response evaluation process, said providing, said obtaining, said classifying, and said matching are repeated only when the face emotion of the second facial image for one challenge of the challenge-response evaluation process matches the face emotion associated with the at least one media item of said one challenge of the challenge-response evaluation process.

8. (canceled)

9. The method according to claim 1, wherein the method further comprises:
classifying the first facial image to one of the face emotions in the set of available face emotions by performing face emotion recognition on the first facial image, wherein the at least one media item in the challenge-response evaluation process is selected from the set of available media items for the user as a function of the face emotion of the first facial image.

10. The method according to claim 1, wherein performing the challenge-response evaluation process further comprises:
recognizing the user by performing facial recognition on the second facial image before successfully authenticating the user.

11. (canceled)

12. The method according to claim 1, wherein playing out the at least one media item to the user comprises transforming the at least one media item from a first type to a second type.

13. (canceled)

14. An authentication device for two-factor facial recognition authentication of a user, the authentication device comprising processing circuitry, the processing circuitry being configured to cause the authentication device to:
perform a facial recognition process, according to which the processing circuitry causes the authentication device to:
obtain, via an image sensor, a first facial image of the user; and
recognize the user by performing facial recognition on the first facial image; and
perform a challenge-response evaluation process, according to which the processing circuitry causes the authentication device to:
provide a challenge to the user by playing out at least one media item to the user, wherein the at least one media item is selected from a set of available media items for the user and is associated with a face emotion selected from a set of available face emotions;
obtain, via the image sensor, a response to the challenge from the user, wherein the response is a second facial image of the user;
classify the second facial image to one of the face emotions in the set of available face emotions by performing face emotion recognition on the second facial image; and
successfully authenticate the user, responsive to the face emotion of the second facial image matching the face emotion associated with the at least one media item.

15. The authentication device according to claim 14, wherein each of the face emotions in the set of available face emotions that are associated with each of the media items in the set of available media items is defined by any, or any combination of: an implicit mapping learned whilst playing out the media item in the set of available media items, a training procedure, and an explicit mapping provided by the user.

16. The authentication device according to claim 14, wherein, during the challenge-response evaluation process, said providing, said obtaining, said classifying, and said matching are repeated for a set of challenges as provided to the user, wherein during each challenge a respective media item is selected from the set of available media items.

17. The authentication device according to claim 16, wherein each transition from the at least one media item played out for a current challenge and the at least one media item played out for a next challenge is associated with a face emotion selected from a set of available face emotions, and wherein the processing circuitry is configured to cause the authentication device, as part of performing the challenge-response evaluation process:
obtain, from the image sensor, a third facial image of the user for each transition;
classify the third facial image for each transition to one of the face emotions in the set of available face emotions by performing face emotion recognition on each third facial image; and
confirm that the face emotion of each third facial image matches the face emotion of the transitions before successfully authenticating the user.

18. The authentication device according to claim 16, wherein for how many iterations said providing, said obtaining, said classifying, and said matching are to be repeated depends on a targeted authentication level at which the user is to be authenticated, and wherein at least two media items of different types are simultaneously played out to the user when providing the challenge to the user.

19. The authentication device according to claim 16, wherein, during the challenge-response evaluation process, said providing, said obtaining, said classifying, and said matching are repeated until the face emotion of the second facial image for one challenge of the challenge-response evaluation process matches the face emotion associated with the at least one media item of said one challenge of the challenge-response evaluation process.

20. The authentication device according to claim 16, wherein, during the challenge-response evaluation process, said providing, said obtaining, said classifying, and said matching are repeated only when the face emotion of the second facial image for one challenge of the challenge-response evaluation process matches the face emotion associated with the at least one media item of said one challenge of the challenge-response evaluation process.

21. (canceled)

22. The authentication device according to claim 14, the processing circuitry further being configured to cause the authentication device to:
classify the first facial image to one of the face emotions in the set of available face emotions by performing face emotion recognition on the first facial image, wherein the at least one media item in the challenge-response evaluation process is selected from the set of available media items for the user as a function of the face emotion of the first facial image.

23. The authentication device according to claim 14, wherein the processing circuitry is configured to cause the authentication device, as part of performing the challenge-response evaluation process:
recognize the user by performing facial recognition on the second facial image before successfully authenticating the user.

24. (canceled)

25. The authentication device according to claim 14, wherein playing out the at least one media item to the user comprises transforming the at least one media item from a first type to a second type.

26-28. (canceled)
